(19) United States
(12) Patent Application Publication
(10) Pub. No.: US 2009/0090791 A1
(43) Pub. Date: Apr. 9, 2009

(54) OVER-SPRAY CAPTURING DEVICE AND ITS USE

(76) Inventor: Charles B. DORENBUSCH, Cincinnati, OH (US)

Correspondence Address: HASSE & NESBITT LLC, 8837 CHAPEL SQUARE DRIVE, SUITE C, CINCINNATI, OH, 45249, US

(21) Appl. No.: 11/867,055

(22) Filed: Oct. 4, 2007

(51) Int. Cl. B05B 15/04; B05D 1/02

(52) U.S. Cl. 239/1; 239/602

(57) ABSTRACT

An over-spray blocking device for use to capture the over-spray of a sprayed liquid, such as a garden solution, made by manipulating a formed planar sheet into a funnel-shape, including a manipulable, substantially planar sidewall including an outer periphery, an inner rim defining an inner opening, and side edges defining a slot joining the inner rim to the outer periphery, and a pair of handles extending from side edges of the outer periphery, as a means for temporarily holding the side edges in overlapping position when the planar sidewall is manipulated into the funnel shape.

### BACKGROUND OF THE INVENTION

Gardening and landscaping utilizes various herbicides to control or eradicate certain unwanted plants such as weeds, pesticides to control or eradicate pests such as bugs, and fertilizers to provide nutrition to plants. When spraying a pesticide or fertilizer onto a target plant, over-spraying (the portion of a spray or mist of a liquid material that does not adhere or adsorb to the target plant) generally falls to the ground or other plants or articles that surround the target plant, often with little or no consequence, but sometime with certain mal-consequences, such as staining or the unintended eradication of beneficial bug life on the surrounding area. When spraying a herbicide onto a target plant, typically a weed or other plant that one wishes to eliminate, over-spraying generally falls to the ground or other plants or articles that surround the target plant, often with the mal-consequence of also eradicating such desirable plants that one has no intention of harming.

One means of capturing such over-spraying of sprayed garden solutions is described in U.S. Pat. No. 6,065,244, issued May 23, 2000, the disclosure of which is incorporated herein by reference, which relates to a one-piece manual garden spray shield that is placed around undesirable vegetation for spraying a herbicide thereon while protecting surrounding desirable vegetation. The one-piece manual garden spray shield is generally a molded, funnel-shaped shield has an elongated slot along one side and through the truncated funnel body and bottom cylindrical portion. A handle is attached along a side so that the shield can be quickly placed over the side of a plant stem and held in position while hand spraying the plant. The device is described as shielding the surrounding vegetation during the application of the herbicide. The spray shield is described as being molded as a single unit from polymer or plastic materials.

The funnel-shaped shield also provides a funnel for assisting in the pouring of a liquid from one container into a second container having a relatively small diameter opening. The bottom cylindrical portion is placed into the open end of a cylindrical pour spout of a first container, so that a liquid in a second container can be poured onto and through the funnel-shaped shield.

Similar problems with over-spray can occur with other sprayed liquids, such as lacquers, varnishes, paint, cleaning solvents and solutions, etc. that are being applied to elongated objects, such as the leg of a chair.

Nevertheless, there remains a need to provide a capturing the over-spray of sprayed garden solutions, which provides great flexibility of use with plants of all sized and shapes, and which is easy to handle and store. There also remains a need to provide an improved funnel for pouring liquids from one container into an opening of a second container, which is easy to handle and store.

### SUMMARY OF THE INVENTION

One aspect of the present invention provides an over-spray capturing device that is adapted from a flexible, planar sheet including a central aperture and a slot communicating the aperture to the periphery of the planar sheet, which can be manipulated or folded by hand into a hand-held device.

Another aspect of the present invention provides an over-spray capture device with an opening adapted to surround an elongated article, such as the trunk, branch or stem of a target vegetation or plant, the opening comprising a means for enlarging the effective opening size to accommodate elongated articles, such as plant stems and trunks, of various sizes.

Another aspect of the present invention provides an over-spray capture device that can be adapted by hand from a formed, planar sheet of material into a three-dimensional device having an opening through which an elongated article, such as the stem, branch or trunk of a vegetation or plant, can be disposed.

The present invention relates to a formed planar sheet manually adaptable into an over-spray blocking device to capture the over-spray of a sprayed liquid or solution, comprising: a) a manipulable, substantially planar sidewall including a first and second edge, an outer periphery, an inner rim defining an inner opening, and a slot joining the inner rim to the outer periphery, and separating the first edge and a second edge, b) at least one handle extending from a first portion of the outer periphery, and c) a means for temporarily holding the first edge and the second edge in overlapping position when the planar sidewall is manipulated into a funnel shape, to provide the over-spray blocking device.

The present invention also relates to an over-spray blocking device for use to capture the over-spray of a sprayed liquid or solution, comprising: a) a funnel portion having a sidewall having an inner edge defining an inner opening, an outer edge defining an outer periphery, a first edge extending from a first end of the inner edge to a first end of the outer edge, and a second edge extending from a second end of the inner edge to a second end of the outer edge, the first edge and the second edge at least partially overlapping; b) a first handle extending from the first end of the outer periphery; and c) a means for temporarily holding the first edge and the second edge in the overlapping position.

The present invention further relates to a method for capturing the over-spray of a sprayed liquid or solution onto an elongated article, such as a garden solution on a part of a vegetation, comprising the steps of: i) providing a formed planar sheet comprising a) a manipulable, substantially planar sidewall including a first and second edge, an outer periphery, an inner rim defining an inner opening, and a slot joining the inner rim to the outer periphery, and separating the first edge and a second edge, b) at least one handle extending from a first portion of the outer periphery, and c) a means for temporarily holding the first edge and the second edge in overlapping position when the planar sidewall is manipulated into a funnel shape, to provide the over-spray blocking device; ii) placing the formed planar sheet around the elongated article, such as the stem or branch of a plant, and positioning the elongated article proximate the opening; iii) manipulating the formed planar sheet to form a funnel device having a sidewall and a first handle extending from the first portion of the periphery; and a means for holding the first end edge in the position overlapping the second end edge; and iv) holding the funnel-shaped device with the sidewalls positioned behind the article; wherein the over-spray of liquid or solution sprayed onto the article is captured onto the sidewalls.

### BRIEF DESCRIPTION OF THE DRAWINGS

FIG. 1 shows a plan view of a formed sheet of the present invention that is manually adaptable into an over-spray blocking device.

FIG. 2 shows a plan view of an over-spray blocking device of the present invention having a funnel shape, adapted by manipulating the formed sheet of FIG. 1.

FIG. 3 shows a sectional elevation view of the formed sheet of FIG. 1 as viewed through line 3-3 thereof.

FIG. 4 shows a sectional elevation view of the over-spray blocking device of FIG. 2 as viewed through line 4-4 thereof.

FIG. 5 shows a perspective view of the over-spray blocking device of FIG. 2.

FIG. 6 shows the formed sheet positioned around the base stem of a plant.

FIG. 7 shows the formed sheet manipulated into the over-spray blocking device, and positioned to capture the over-spray of a garden solution sprayed onto the plant.

FIG. 8 shows a plan view of an alternative embodiment of the formed sheet including a plurality of secondary slots disposed around and extending radially from the inner opening to define a plurality of tabs.

FIG. 9 shows a plan view of an alternative over-spray blocking device of the present invention having a funnel shape, adapted by manipulating the formed sheet of FIG. 8.

FIG. 10 shows a plan view of the over-spray blocking device of FIG. 9 after its positioning and manipulation around the elongated article, such as the base stem of a plant.

FIG. 11 shows a plan view of another alternative embodiment of the formed sheet having a periphery with linear portions.

FIG. 12 shows a plan view of another over-spray blocking device of the present invention having a funnel shape, adapted by manipulating the planar, formed sheet of FIG. 11.

### DETAILED DESCRIPTION OF THE INVENTION

Definitions:

The term or phrase “manipulable” means that the article or device can be bent, folded or otherwise changed in form with the hands or fingers only, without the need of an assisting tool or device.

The term or phrase “sprayed” means a liquid that is formed into a stream or droplets, typically by aerosol or other pressurized spraying means.

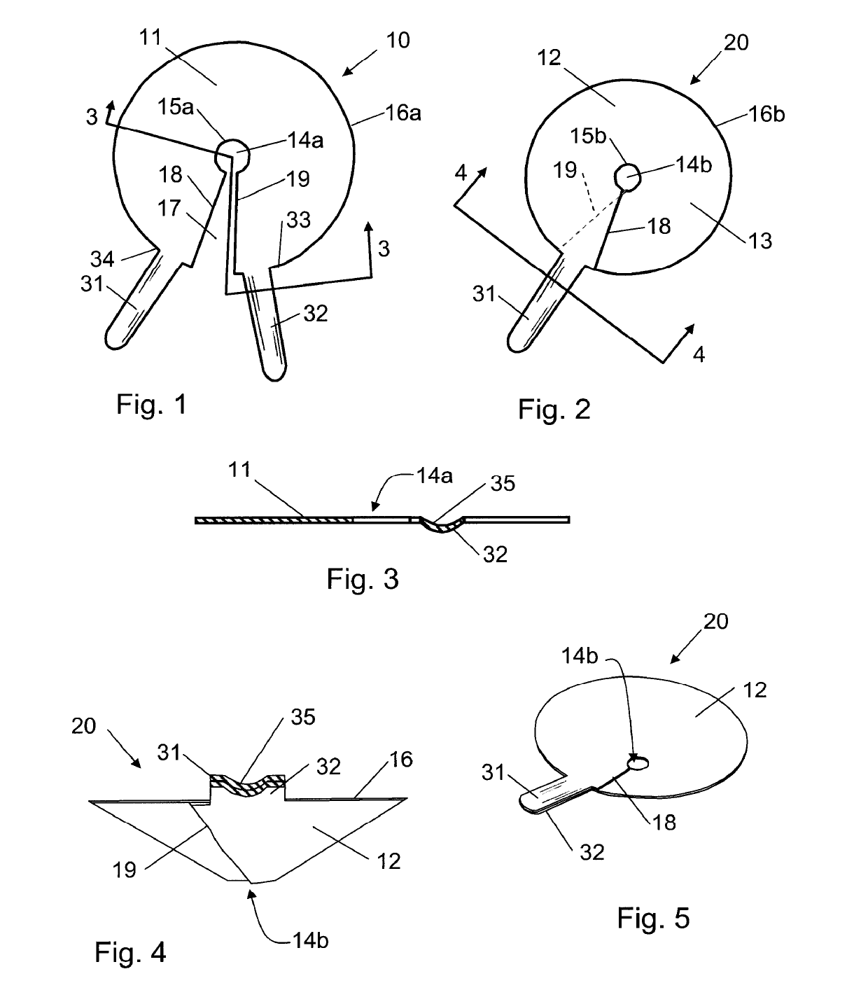

FIGS. 1 and 3 show an embodiment of a formed planar sheet 10 manually adaptable into an over-spray blocking device 20, shown in FIGS. 2, 4 and 5, to capture the over-spray of a sprayed garden solution. The formed planar sheet 10 comprises a manipulable, substantially planar sidewall 11, at least one handle extending from a first portion 34 of the outer periphery, and a means for temporarily holding the first edge and the second edge in overlapping position when the planar sidewall 11 is manipulated into a funnel shape, to provide the over-spray blocking device 20.

The planar sidewall 11 includes a first edge 18 and second edge 19, an outer periphery 16a, an inner rim 15a defining an inner opening 14a, and a slot 18 joining the inner rim 15a to the outer periphery 16a, and separating the first edge 18 and a second edge 19. The overall shape of the planar sidewall is “C” shaped. In the illustrated embodiment, the shapes of the outer periphery 16a and the inner rim 15a are circular.

The at least one handle 31 is typically integral with and extends outward from the outer periphery 16ba of the planar sidewall 11, typically from a position proximate the first edge 18. Typically a second handle 32 is provided, extending outward from a second portion of the outer periphery 16a of the planar sidewall 11, typically from a position proximate the second edge 19. The at least one handle 31 and the second handle 32 are typically formed having a curved profile 35 transverse to the length of said handle, as shown in FIG. 3. The curved profile 35 of the handle 31 typically extends the entire length of the handle, and beyond the length into at least part of the planar sidewall 11. The curved profile 35 provides the handle with strength to prevent bending along the length of the handle in use. The second handle 32 provides a means for temporarily holding the first edge 18 and the second edge 19 of the sidewall 11 in overlapping position when the planar sidewall 11 is manipulated into a funnel shape, by overlapping the first handle 31 and second handle 32 to form a composite handle. Other means for temporarily holding the first and second edges can include a tab and slot, a button, a snap, a hook and loop fastener, and other well known means.

The inner opening 15 a is typically substantially centered within the planar sidewall 11, which surrounds the opening in the shape of a “C”.

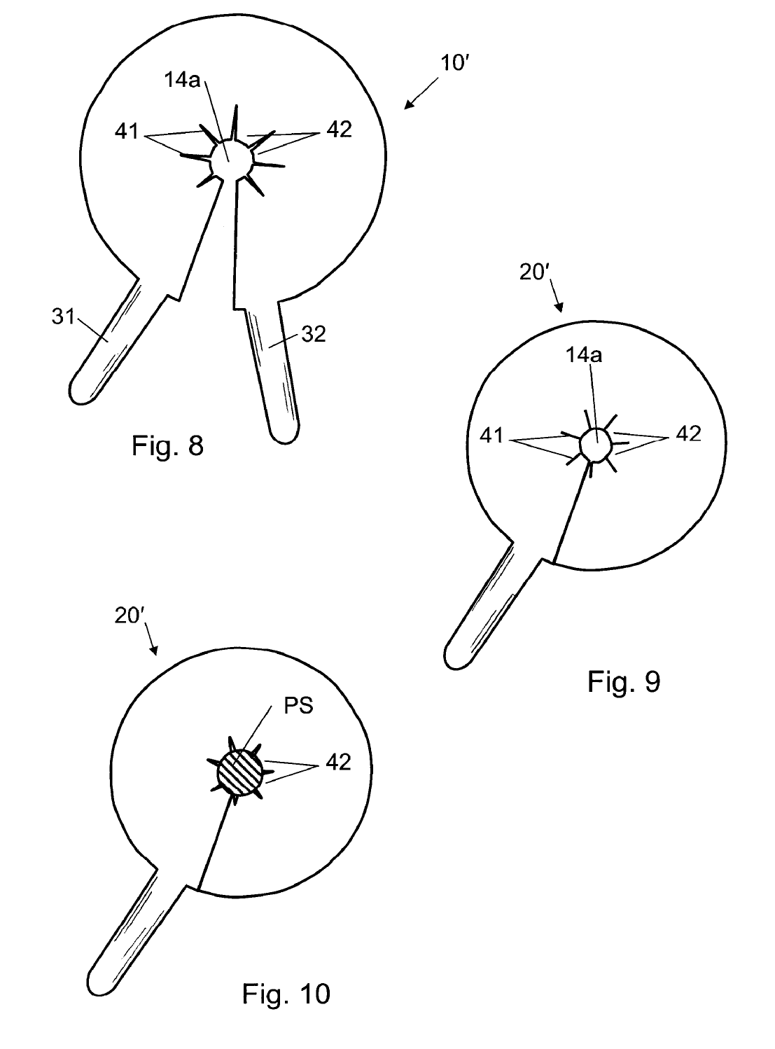

In an alternative embodiment shown in FIGS. 8-10, the formed planar sheet 10′ includes a plurality of secondary slots 41 disposed around and extending radially from the inner opening 14a to define a plurality of tabs 42. Each of the tabs 42 can be folded transverse to the radial direction, providing an effectively larger opening for positioning around a larger diameter plant stem PS.

Referring to FIG. 1, the planar sheet 11 is typically a manipulable material, typically in sheet form. The sheet is sufficiently flexible to allow bending or curving of the planar shape by the force of the hands. The sheet is sufficiently resilient to allow folding of the sheet into a three-dimension funnel shape, without spontaneously forming a crease or fold line in the sidewall, and to allow return of the manipulated material to the planar form after the manipulating force is removed. Typical sheets can be made of plastic, paper, plastic-coated paper, plastic and paper laminates, treated paper, and the like. The sheet typically has a thickness of at least about 5 mil (0.005 inches), and up to about 0.25 inches.

The planar sheet can be clear, colored, translucent, transparent, opaque, two-or more-colored, printed, painted, patterned, etc. Advertisements, instructions illustrations and any conceivable graphic or text can be formed onto either or both surfaces of the planar sheet.

Referring to FIG. 2, the over-spray blocking device 20 formed from the formed planar sheet comprises a funnel portion 12, a first handle 31 and optionally a second handle 32, and a means for temporarily holding first and second edges of the funnel portion in an overlapping position.

The funnel portion 12 includes a sidewall 13 having an inner edge 11b defining an inner opening 14b, an outer edge 16b defining an outer periphery, a first edge 18 extending from a first end of the inner edge 15b to a first end of the outer edge 16b, and a second edge 19 extending from a second end of the inner edge 15b to a second end of the outer edge 16b, the first edge 18 and the second edge 19 at least partially overlapping. The sidewall 13 is typically formed into a conical sidewall as shown in FIGS. 2, 4 and 5.

The first handle 31 extends from the first end 34 of the outer edge 16b, and the second handle 32 extends from the second end 33 of the outer edge 16b, and are overlapped to form the composite handle.

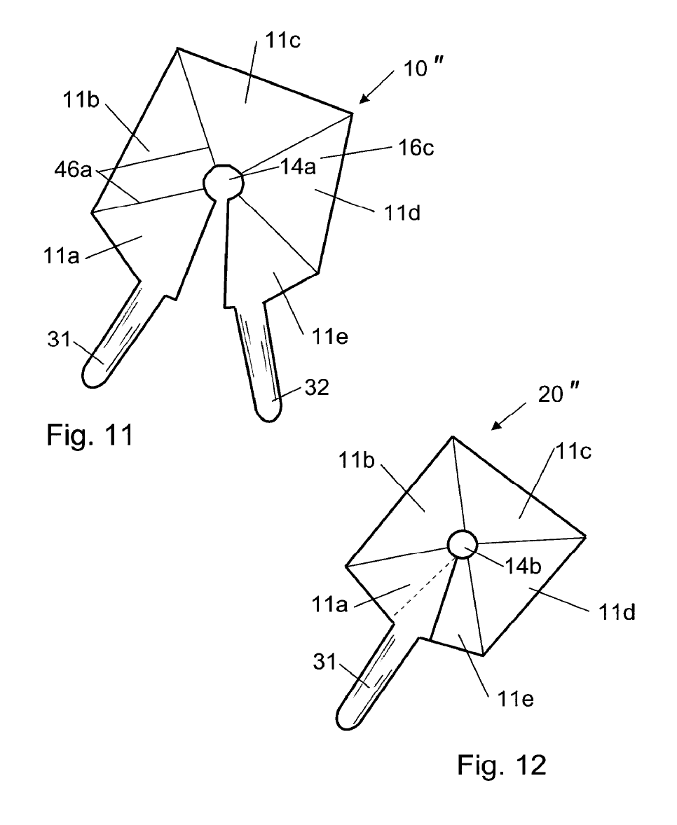

In another embodiment shown in FIGS. 11 and 12, the formed planar sheet 10″ includes an outer periphery including the outer edges 16c of a plurality of rectilinear sidewall panels 11a, 11b, 11c, 11d and 11e. Each of the adjacent panels 11 share a fold or crease line 46, extending from proximate the opening 1ac to proximate the outer periphery. The manipulation of the handles 31 and 32 into overlapping position shown in FIG. 12 adapts the formed planar sheet 10″ into a pyramidal-shaped funnel 20″.

Use of the device is now described for capturing the over-spray of a sprayed liquid or solution onto an article, including but not limited to a garden solution onto a plant. The present invention relates to a method for capturing the over-spray of a sprayed solution onto an elongated article, such as a branch, flower, or other part of vegetation or a plant. The method comprises the steps of: i) providing a formed planar sheet comprising a manipulable, substantially planar sidewall including a first and second edge, an outer periphery, an inner rim defining an inner opening, and a slot 18 joining the inner rim to the outer periphery, and separating the first edge and a second edge, b) at least one handle extending from a first portion of the outer periphery, and c) a means for temporarily holding the first edge and the second edge in overlapping position when the planar sidewall is manipulated into a funnel shape, to provide the over-spray blocking device; ii) placing the formed planar sheet around an elongated member of the article, such as the base stem of a plant, and positioning the article proximate the opening; iii) manipulating the formed planar sheet to form a funnel device having a sidewall and a first handle extending from the first portion of the periphery; and a means for holding the first end edge in the position overlapping the second end edge; and iv) holding the funnel-shaped device with the sidewalls positioned behind the article; wherein the over-spray of liquid or solution sprayed onto the plant is captured onto the sidewalls.

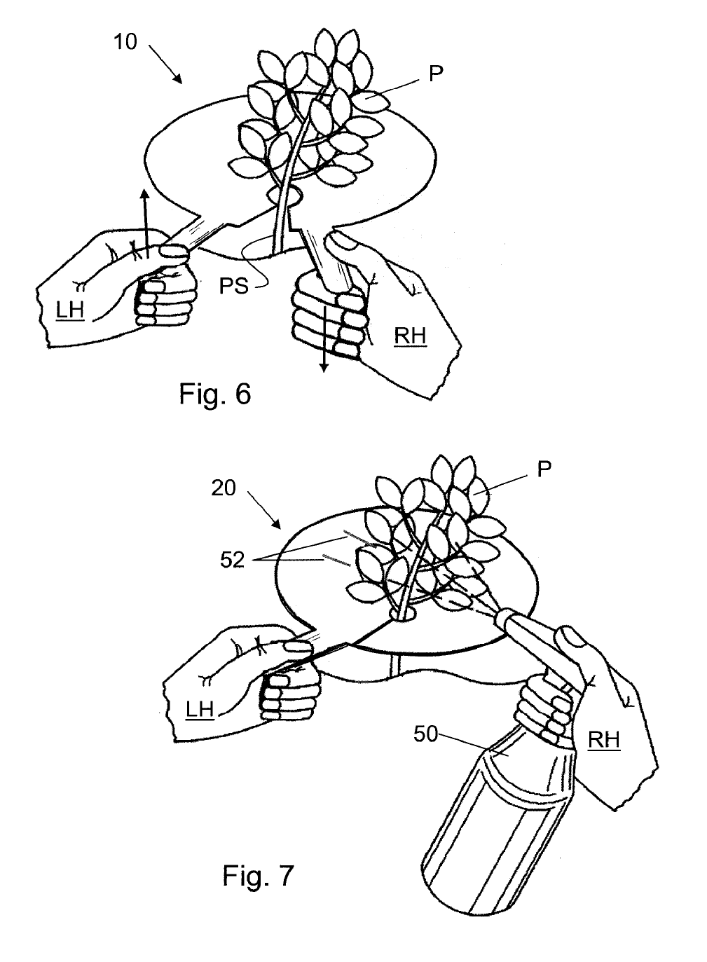

The formed planar sheet is typically grasped by the two handles, and with gentle separating of the handles, the device 10 is placed around an elongated member of an article, such as the stem base (PS) of a plant (P) as shown in FIG. 6. The handles are conveniently separated in opposite directions normal to the planar sheet to optimize the opening. Once positioned with the plant stem (PS) disposed within the opening, the two handles are pulled together, one registered over the other by hand into overlapping position, thereby overlapping the first and second edges of the sidewall, and folding or manipulating the planar sidewall into a funnel. As shown in FIG. 7, the two handles can be grasped on one hand (LH) while a dispenser 50 of garden solution is held in the other hand (RH). The sidewall of the funnel extends outward from opening to capture the over-spray of the sprayed garden solution onto the plant and its foliage.

The liquid or solution can be a sprayable solution that can be discharged by a spraying means as a stream or droplets of liquid. The liquid or solution can be a garden solution including, but not limited to, a herbicide, insecticide, fertilizer or other well known solution used in a garden and sprayed upon selected plants and foliage, a lacquer, a varnish, a paint, a cleaning solvent or solution.

While the invention has been disclosed by reference to the details of preferred embodiments of the invention, it is to be understood that the disclosure is intended in an illustrative rather than in a limiting sense, as it is contemplated that modifications will readily occur to those skilled in the art, within the spirit of the invention and the scope of the appended claims.

I claim:

1. A formed planar sheet manually adaptable into an over-spray blocking device to capture the over-spray of a sprayed liquid, comprising:
a) a manipulable, substantially planar sidewall including a first and second edge, an outer periphery, an inner rim defining an inner opening, and a slot joining the inner rim to the outer periphery, and separating the first edge and a second edge,
b) at least one handle extending from a first portion of the outer periphery, and
c) a means for temporarily holding the first edge and the second edge in overlapping position when the planar sidewall is manipulated into a funnel shape, to provide the over-spray blocking device.

2. The formed planar sheet according to claim 1 wherein the temporary holding means comprises a second handle extending from a second portion of the outer periphery, wherein the first portion and the second portion of the outer periphery are disposed proximate the first and second edges, respectively.

3. The formed planar sheet according to claim 2 wherein the at least one handle and the second handle are formed integrally with the planar sidewall, and each said handle has a curved profile transverse to the length of said handle.

4. The formed planar sheet according to claim 3 wherein the curved profile extends beyond the length of the at least one handle and into at least part of the planar sidewall.

5. The formed planar sheet according to claim 1 wherein the inner opening is circular, and substantially centered within the planar sidewall.

6. The formed planar sheet according to claim 1 wherein the planar sheet has a plurality of secondary slots disposed around and extending radially from the inner opening to define a plurality of tabs.

7. The formed planar sheet according to claim 1 wherein the planar sheet includes a circular portion and the outer periphery is circular.

8. An over-spray blocking device for use to capture the over-spray of a sprayed liquid, such as a garden solution, comprising:
a) a funnel portion having a sidewall having an inner edge defining an inner opening, an outer edge defining an outer periphery, a first edge extending from a first end of the inner edge to a first end of the outer edge, and a second edge extending from a second end of the inner edge to a second end of the outer edge, the first edge and the second edge at least partially overlapping;
b) a first handle extending from the first end of the outer periphery; and
c) a means for temporarily holding the first edge and the second edge in the overlapping position.

9. The over-spray blocking device according to claim 8 wherein the temporary holding means comprises a second handle extending from the second end of the outer periphery.

10. The over-spray blocking device according to claim 9 wherein the first handle and the second handle are formed integrally with the funnel portion, and each said handle has a curved profile transverse to the length of said handle.

11. The over-spray blocking device according to claim 10 wherein the curved profile of each of the handles extends beyond the length of said handle and into at least part of the funnel portion.

12. The over-spray blocking device according to claim 8 wherein the inner opening is circular, and substantially centered within the funnel portion.

13. The over-spray blocking device according to claim 12 wherein the funnel portion is conical and the outer periphery is circular.

14. The over-spray blocking device according to claim 8 wherein the funnel portion has a plurality of secondary slots disposed around and extending radially from the inner opening to define a plurality of tabs.

15. The over-spray blocking device according to claim 10 wherein the first handle registers over the second handle to form a composite handle.

16. A method for capturing the over-spray of a sprayed liquid, such as a garden solution, onto an elongated object, such as a part of vegetation, comprising the steps of:
i) providing a formed planar sheet comprising a manipulable, substantially planar sidewall including a first and second edge, an outer periphery, an inner rim defining an inner opening, and a slot joining the inner rim to the outer periphery, and separating the first edge and a second edge, b) at least one handle extending from a first portion of the outer periphery, and c) a means for temporarily holding the first edge and the second edge in overlapping position when the planar sidewall is manipulated into a funnel shape, to provide the over-spray blocking device;
ii) placing the formed planar sheet around the elongated article, such as the base stem of a plant, and positioning the elongated article proximate the opening;
iii) manipulating the formed planar sheet to form a funnel device having a sidewall and a first handle extending from the first portion of the periphery; and a means for holding the first end edge in the position overlapping the second end edge; and
iv) holding the funnel-shaped device with the sidewalls positioned behind the article;
wherein the over-spray of liquid sprayed onto the article is captured onto the sidewalls.

17. The method according to claim 16 wherein the securing means comprises a second handle extending from a second portion of the outer periphery, wherein the first portion and the second portion of the outer periphery are disposed on opposite sides of the slot.

18. The method according to claim 16 where wherein the circular portion has a plurality of secondary slots disposed around and extending radially from the opening to define a plurality of tabs that define the opening, wherein the manipulating step iii) comprises folding at least one of the plurality of tabs.

19. The method according to claim 16 wherein the first handle registers over the second handle to form a composite handle.

20. The method according to claim 16 wherein the funnel portion is conical and the outer periphery is circular.
